(19) United States
(12) Patent Application Publication
(10) Pub. No.: US 2019/0079805 A1
(43) Pub. Date: Mar. 14, 2019

(54) EXECUTION NODE SELECTION METHOD AND INFORMATION PROCESSING APPARATUS

(71) Applicant: FUJITSU LIMITED, Kawasaki-shi (JP)

(72) Inventor: Ryota Sakurai, Numazu (JP)

(73) Assignee: FUJITSU LIMITED, Kawasaki-shi (JP)

(21) Appl. No.: 16/053,169

(22) Filed: Aug. 2, 2018

(30) Foreign Application Priority Data
Sep. 8, 2017 (JP) 2017-173488

(51) Int. Cl. G06F 9/52; G06F 9/48

(52) U.S. Cl. CPC G06F 9/52; G06F 9/4881

(57) ABSTRACT

An extracting unit extracts a candidate NUMA node that becomes a candidate for executing a task and a calculation unit calculates, regarding the data used by the task, the size of the data held by the candidate NUMA node. Then, a deciding unit decides, by using the size of the data held by the candidate NUMA node and by using a latency table, a NUMA node that executes the task from among the candidate NUMA nodes. Then, the deciding unit registers the thread ID of a thread belonging to the decided NUMA node into the task pool.

### CROSS-REFERENCE TO RELATED APPLICATION

This application is based upon and claims the benefit of priority of the prior Japanese Patent Application No. 2017-173488, filed on Sep. 8, 2017, the entire contents of which are incorporated herein by reference.

### FIELD

The embodiment discussed herein is related to an execution node selection method and an information processing apparatus.

### BACKGROUND

Task syntax of OpenMP that is the thread parallelization standard is used to perform parallel execution by cutting an arbitrary block from a program as a task. Here, the “thread” is a unit of parallel execution performed on the program. The program is executed in parallel by threads the number of which is designated by a user. The program is created by the language, such as C, C++, or FORTRAN.

If a compiler finds the task syntax in a source program, the compiler inserts an I/F that calls a run time routine that performs a process related to the task into an execution program. FIG. 19A is a diagram illustrating an example of compiling a program including the task syntax. In FIG. 19A, a source file is a file that stores therein a source program and an execution file is a file that stores therein an execution program executed by a parallel computer. In FIG. 19A, “#pragma omp task” in the source program is the task syntax that designates to cut out the block enclosed by { } as a task.

As illustrated in FIG. 19A, the compiler cuts out two tasks from the source program and inserts two task registration I/Fs into the execution program. In FIG. 19A, task#1 and task#2 that are arguments are function pointers indicating the top position of a process of the content of the task. Furthermore, the compiler inserts a task execution I/F into the execution program.

FIG. 19B is a diagram illustrating an operation of the execution program illustrated in FIG. 19A. As illustrated in FIG. 19B, if the task registration I/F is executed, information on the tasks is registered in the task pool (1). Here, the task pool is a list of information on the tasks to be executed and holds information on function pointers or the like. In FIG. 19B, the pieces of information on task#1 and task#2 are registered to the task pool. The task registration I/Fs are executed in a single thread. At this point, the task is not executed. Then, if the task execution I/F is executed, all of the tasks in the task pool are executed (2). The task execution I/F is executed in all threads.

The OpenMP program is sometimes executed in a non-uniform memory access (NUMA) environment. Here, the OpenMP program is a program that is based on OpenMP. Furthermore, NUMA is an architecture in which an access to each memory by a core is not uniform. In NUMA, a plurality of NUMA nodes each of which includes a core and a memory is present and each of the NUMA nodes share the memories.

A memory that is present in the same NUMA node viewed from a certain core is referred to as a local memory and a memory that is present in a different NUMA node is referred to as a remote memory. Furthermore, an access to a local memory is referred to as a local access and an access to a remote memory is referred to as a remote access. In general, remote access time is greater than local access time.

The task syntax does not have a function of designating a NUMA node that executes a task and which NUMA node executes the task depends on implementation of run time. When a task is executed in a NUMA environment, if a NUMA node that executes the task is different from a NUMA node in which data accessed by the task is present, the access to the data becomes a remote access, resulting in a decrease in performance of the task.

FIG. 20 is a diagram illustrating a case in which the performance of a task is decreased in a NUMA environment. In FIG. 20, NUMA#0 and NUMA#1 are NUMA nodes connected by interconnection. The symbols C#0 to C#3 are cores. The symbols cache#0 and cache#1 are cache memories. The cache memory represented by cache#0 is shared by C#0 and C#1 and cache#1 is shared by C#2 and C#3. The symbols MEM#0 and MEM#1 are memories.

For example, C#0 that executes a task accesses MEM#0 via cache#0 in a case of a local access and accesses NUMA#1 via interconnection in a case of a remote access. If C#0 accesses the data in MEM#1, the content of MEM#1 is read out into cache#1 and stored in cache#0 via interconnection. In this way, if the NUMA node that executes a task is different from a NUMA node that stores therein data accessed by the task, the performance of the task is degraded because remote accesses are always generated.

Consequently, there is a technology for identifying, by adding a designation clause in which a single variable used in a task is described to the task syntax, a NUMA node to which the variable belongs on the basis of the address of the variable at the time of registration of the task and executing the task in the identified NUMA node.

FIG. 21 is a diagram illustrating an example of an execution program created by compiling the task syntax that includes a designation clause. In FIG. 21, “numa_val(a)” is a designation clause in which a variable a that is accessed by the task is described and “numa_val(b)” is a designation clause in which a variable b that is accessed by the task is described.

The compiler inserts the task registration I/F into the execution program by including the address of the variable accessed by the task in the argument. In FIG. 21, “task registration I/F (task#1,&a)” is inserted in association with “#pragma omp task numa_val(a)”. Furthermore, “task registration I/F (task#1,&b)” is inserted in association with “#pragma omp task numa_val(b)”. The symbol “&v” is the address of a variable v.

FIG. 22A is a diagram illustrating an operation of the task registration I/F in which a variable address is included in the argument and FIG. 22B is a diagram illustrating an operation of the task execution I/F. As illustrated in FIG. 22A, if the task registration I/F in which the variable address is included in the argument is called from a user program, a registration-purpose run time routine is called by using the variable address as the argument (1). Then, the registration-purpose run time routine calls a node ID return routine by using the variable address as the argument (2).

Then, the node ID return routine identifies the NUMA node to which the variable belongs by using the variable address of the argument and returns the NUMA node ID to which the variable belongs (3). Here, the NUMA node ID is an identifier for identifying a NUMA node.

Then, the registration-purpose run time routine registers all of the thread IDs of the threads associated with the core included in the NUMA node that is identified by the returned NUMA node ID in the task pool together with the function pointer (4). Here, the thread ID is an identifier for identifying a thread. In FIG. 22A, the prioritized executed thread ID_1, the prioritized executed thread ID 2, and the like are the thread IDs of the threads associated with the core included in the NUMA node that is identified by the NUMA node ID.

Then, if the task execution I/F has been executed, as illustrated in FIG. 22B, an execution-purpose run time routine is called (1). The execution-purpose run time routine loads information from the task pool (2). Then, the execution-purpose run time routine allocates the task to the thread with the prioritized executed thread ID_1 and, if the task is not able to be allocated, the execution-purpose run time routine allocates the task to the thread with the prioritized executed thread ID_2 (3).

In this way, the registration-purpose run time routine identifies the NUMA node to which the variable designated by the argument belongs and registers, in the task pool, the thread ID of the thread associated with the core included in the identified NUMA node. Thus, the NUMA node to which the variable belongs can execute the task.

Furthermore, in a distributed shared memory parallel computer, there is a technology for creating a parallel program that implements optimum data distribution and improving a processing speed of parallel program. In this technology, in a parallel unit of a parallelization compiler, first, a data distribution target array detection unit detects, from an input sequential program, an array that is referenced in a loop in which the loop repetition range is variable, an array in which the array declaration size is variable, or an argument array. Then, a data distribution shape deciding unit creates a data distribution indication sentence that is used to allow the array to be subjected to block cyclic distribution into a page size and then inserts the created data distribution indication sentence. Furthermore, a data-distribution-purpose loop distribution shape deciding unit creates a loop distribution indication sentence having the loop distribution shape that is matched with this data distribution shape and inserts the created loop distribution indication sentence. Then, a parallelization loop nest multithreading unit creates a parallel program by multithreading the nested loop including a parallelization loop.

Furthermore, there is a compiler that creates a parallelization program that accesses a local memory and of which the source code is not rewritten by a programmer who uses a shared memory type multiprocessor computer system that uses the NUMA architecture. If the name of an array desired to be accessed to a local memory and the dimension of the array desired to be parallelized are designated as a compile option, the subject compiler stores the name of the array and the dimension of the array in an array table. Then, if a process of allocating the designated array stored in the array table is present in the source code, the compiler adds an initialization loop of the array designated immediately after the allocation process. Furthermore, if the designated array is present in a loop in the source code, the compiler parallelizes the loop that uses the same variable as that used in the designated dimension as a loop control variable.

Furthermore, there is a compile technology for splitting multicores from which needed execution performance can be easily obtained. This compile technology analyzes a task indication sentence and uses a process of allowing the designated part to be tasked and a process of arranging a task to a designated CPU. This compile technology allocates tasks to individual CPUs in accordance with a task division designation of a main part designated by a user and splits the multicores. Regarding the process in which no allocated CPU is designated, the compile technology decides an allocated CPU by determining the correlation with the main task on the basis of a call relationship or a dependency relationship. When splitting CPUs, this compile technology considers copy arrangement of the same process to a plurality of CPUs and implements efficient multicore task splitting by taking into consideration of a balance between a processing speed and the resources.

Patent Document 1: Japanese Laid-open Patent Publication No. 2001-297068

Patent Document 2: Japanese Laid-open Patent Publication No. 2012-221135

Patent Document 3: Japanese Laid-open Patent Publication No. 2010-204979

In a NUMA environment, the range of the NUMA nodes in which a memory is shared is previously determined. Furthermore, a NUMA node in which data treated by a task can be determined before a program is executed. Thus, if data treated by a task is present in a plurality of NUMA nodes, it is conceivable that the performance of the task can be improved by executing the task in the NUMA node having the largest amount of data.

FIG. 23 is a diagram illustrating execution of a task performed in a NUMA node having the largest amount of data. As illustrated in FIG. 23, the pieces of data treated by the task in MEM#0, MEM#1, MEM#2, and MEN#3 with an amount of 50 MB (megabytes), 60 MB, 20 MB, and 80 MB, respectively. In this case, if a task is executed in NUMA#3, because the task accesses, as a local access, the data with 80 MB, it is conceivable to select NUMA#3 as the NUMA node that is used to execute the task.

However, in a data transfer between NUMA nodes, because latency is different, there may be a case in which selecting NUMA#3 is not optimum. FIG. 24 is a diagram illustrating an example of transfer latency among NUMA nodes. In FIG. 24, the transfer latency between NUMA#0 and NUMA#1 and the transfer latency between NUMA#2 and NUMA#3 are 1 and the transfer latency between NUMA#0 and NUMA#2 and the transfer latency between NUMA#1 and NUMA#3 are 2. Furthermore, the transfer latency between NUMA#0 and NUMA#3 and the transfer latency between NUMA#1 and NUMA#2 are 3. In FIG. 24, the transfer latency is indicated by a relative value and, if the transfer latency is 2, the time needed for a remote access is twice longer than the case in which the transfer latency is 1.

Then, a transfer cost between the NUMA nodes is defined by (transfer latency)×(data size). Then, in a case illustrated in FIG. 24, the transfer cost in a case where the task is executed in NUMA#3 is 3×50 MB (NUMA#0)+2×60 MB (NUMA#1)+1×20 MB (NUMA#2)=290. Similarly, the transfer cost in a case where the task is executed in NUMA#0 is 340, the transfer cost in a case where the task is executed in NUMA#1 is 270, and the transfer cost in a case where the task is executed in NUMA#2 is 360. Accordingly, by executing the task in NUMA#1, it is possible to suppress a decrease in performance due to a remote access to the minimum.

### SUMMARY

According to an aspect of an embodiment, a computer-readable recording medium having stored therein an execution node selection program that causes a computer to execute a process includes extracting, as a candidate NUMA node, a NUMA node in which data used by a task that is cut out from a source program is allocated as a portion subjected to parallel execution in a parallel computer that has a plurality of NUMA nodes, calculating the size of the data for each extracted candidate NUMA node, and deciding, based on the calculated size and latency when the data is transferred between the candidate NUMA nodes, a NUMA node that executes the task from among the candidate NUMA nodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the functional configuration of an information processing apparatus according to an embodiment;

FIG. 2 is a diagram illustrating a latency measurement method;

FIG. 3 is a diagram illustrating the format of a numa_val designation clause;

FIG. 4 is a diagram illustrating arguments passed to a run time routine in a task registration I/F;

FIG. 5 is a diagram illustrating an example of a data size table;

FIG. 6 is a diagram illustrating an example of a cost table;

FIG. 7 is a diagram illustrating an operation of the task registration I/F;

FIG. 8 is a flowchart illustrating the flow of a process of the task registration I/F;

FIG. 9 is a flowchart illustrating the flow of a data amount calculation process;

FIG. 10 is a flowchart illustrating the flow of a transfer cost calculation process;

FIG. 11 is a flowchart illustrating the flow of a process of a task execution I/F;

FIG. 12 is a diagram illustrating the hardware configuration of an execution device that is used to explain registration into a task pool;

FIG. 13 is a diagram illustrating a latency table of the execution device illustrated in FIG. 12;

FIG. 14 is a diagram illustrating a program used to explain registration into a task pool;

FIG. 15 is a diagram illustrating arguments of the task registration I/F in the program illustrated in FIG. 14;

FIG. 16 is a diagram illustrating a data size table created about variables illustrated in FIG. 15;

FIG. 17 is a diagram illustrating a cost table calculated from the latency table illustrated in FIG. 13 and the data size table illustrated in FIG. 16;

FIG. 18 is a diagram illustrating a task pool after registration;

FIG. 19A is a diagram illustrating an example of compiling a program including a task syntax;

FIG. 19B is a diagram illustrating an operation of the execution program illustrated in FIG. 19A;

FIG. 20 is a diagram illustrating a case in which the performance of a task is decreased in a NUMA environment;

FIG. 21 is a diagram illustrating an example of an execution program created by compiling task syntax that includes a designation clause;

FIG. 22A is a diagram illustrating an operation of the task registration I/F in which a variable address is included in the argument;

FIG. 22B is a diagram illustrating an operation of the task execution I/F;

FIG. 23 is a diagram illustrating execution of a task performed in a NUMA node having the largest amount of data; and

FIG. 24 is a diagram illustrating an example of transfer latencies between NUMA nodes.

### DESCRIPTION OF EMBODIMENTS

A preferred embodiment of the present invention will be explained with reference to accompanying drawings.

The embodiment does not limit the disclosed technology.

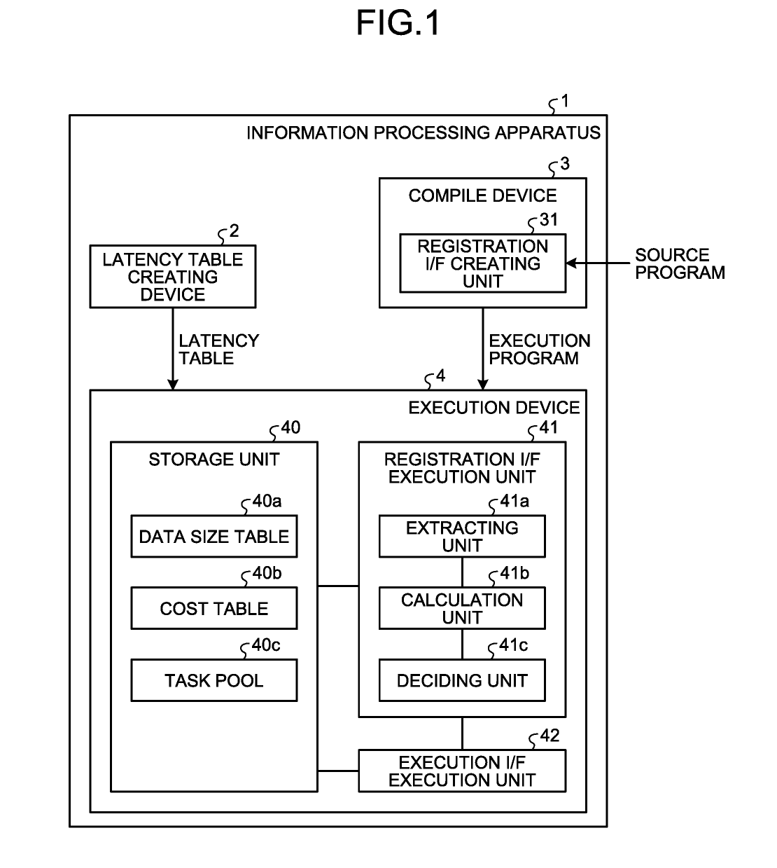

First, the functional configuration of the information processing apparatus according to the embodiment will be described. FIG. 1 is a diagram illustrating the functional configuration of the information processing apparatus according to an embodiment. As illustrated in FIG. 1, an information processing apparatus 1 according to the embodiment includes a latency table creating device 2, a compile device 3, and an execution device 4.

The latency table creating device 2 measures the transfer latency between the NUMA nodes and creates a latency table. The latency table is passed to the execution device 4 via, for example, a file. The latency table creating device 2 creates the latency table at the time of, for example, constructing a parallel computer that includes a plurality of NUMA nodes and then writes data to a file.

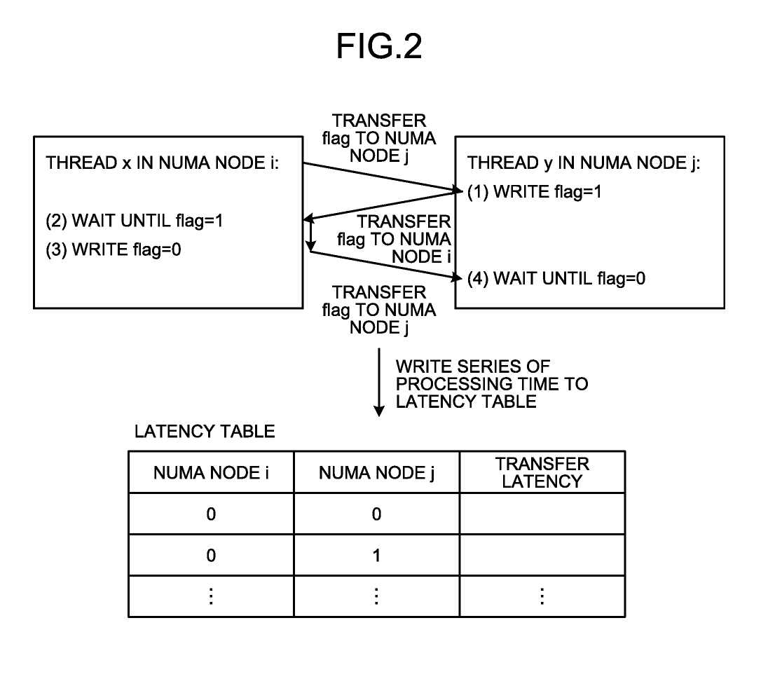

FIG. 2 is a diagram illustrating a latency measurement method. In FIG. 2, the transfer latency between a NUMA node i and a NUMA node j is measured. The latency table creating device 2 allocates a variable flag used for measurement to the memory in the NUMA node i. Then, the latency table creating device 2 measures the processing time taken to update the flag between the NUMA nodes by a timer and obtains the transfer latency.

As illustrated in FIG. 2, the thread belonging to the NUMA node i is set to x and the thread belonging to the NUMA node j is set to y. The thread x waits until the state enters flag=1 and, if flag=1, the thread x writes flag=0, whereas the thread y waits until the state enters flag=0, and, if flag=0, the thread y writes flag=1.

If the thread y reads the flag, based on the state in which the initial value of the flag is zero, the flag is transferred from the NUMA node i to the NUMA node j and, because flag=0, the thread y writs 1 to the flag (1). In contrast, the thread x waits until the state enters flag=1 (2). If the thread x reads the flag, the flag is transferred from the NUMA node j to the NUMA node i and, because flag=1, the thread x writes zero to the flag (3). In contrast, the thread y waits until the state enters flag=0 (4). If the thread y reads the flag, the flag is transferred from the NUMA node i to the NUMA node j.

The latency table creating device 2 measures the period of time needed for the process of updating the flags by the timer and sets the processing time as the transfer latency between the NUMA node i and the NUMA node j. The latency table creating device 2 performs this measurement on all of the combinations of the NUMA nodes and creates the latency table. Furthermore, the latency table creating device 2 performs normalization such that the transfer latency becomes a positive integer. In a case where i=j, this indicates that the transfer latency between the same NUMA node is 0.

The compile device 3 compiles the source program and creates an execution program. The execution program is output to, for example, a file and is read and executed by the execution device 4 from the file. A user designates, in the source program, distribution of data used in the task to each of the NUMA nodes.

Distribution of data used in the task to each of the NUMA nodes is performed by a first touch. The first touch mentioned here is a method of allocating variables to the memories in the NUMA node to which the thread that has accessed the variable (data) first time belongs. When allocating a variable to the memory in the NUMA node i, the user describes the source program such that the thread belonging to the NUMA node i accesses the variable first time. For example, when a plurality of threads is started up by OpenMP, parallelsyntax, or the like and if the program that accesses variables to each of which an initial value is written by a corresponding thread in the program is executed, the variables are allocated to the memories in the NUMA nodes to which the threads belong.

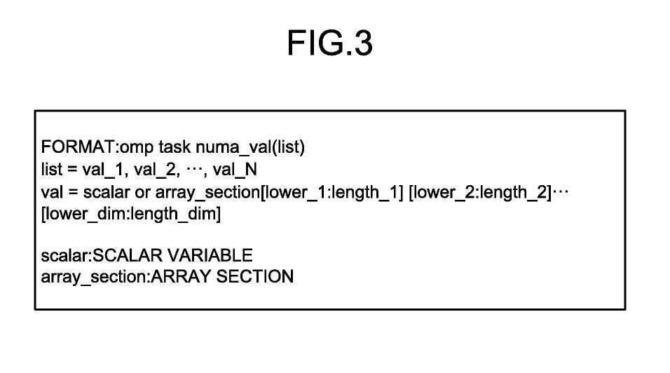

The user designates, in the source program, a plurality of scalar variables and array sections used in the task in a numa_val designation clause. FIG. 3 is a diagram illustrating the format of the numa_val designation clause. As illustrated in FIG. 3, in the numa_val designation clause, the list is designated. The list is a list (val_1, val_2, . . . , and val N) constituted of the number of lists with N scalar variables (scalar) or array sections (array_section).

The index of the array sections is designated by [lower:length], i.e., a start index represented by lower and an array length represented by length. The array section a of [lower:length] represents the array section with the elements of a[lower], a[lower+1], . . . , and a[lower+length−1]. For example, the array section of a[10:5] is the array section in which a[10], a[11], a[12], a[13], and a[14] are the elements.

If an array section is multidimensional, the array section is designated by array_section[lower_1:length_1][lower_2:length_2] . . . [lower_dim:length_dim], where the number of dimensions is represented by dim.

The compile device 3 includes a registration I/F creating unit 31. The registration I/F creating unit 31 compiles the task syntax and inserts the task registration I/F into the execution program. When compiling the task syntax, the registration I/F creating unit 31 creates the task registration I/F in which the function pointer “func” of the task, the number “N” of lists, the top address “addr” of the variable, the size of the type “size” of the variable, the number of dimensions “dim” of the variable, and the index length “len” of each of the dimensions are arguments.

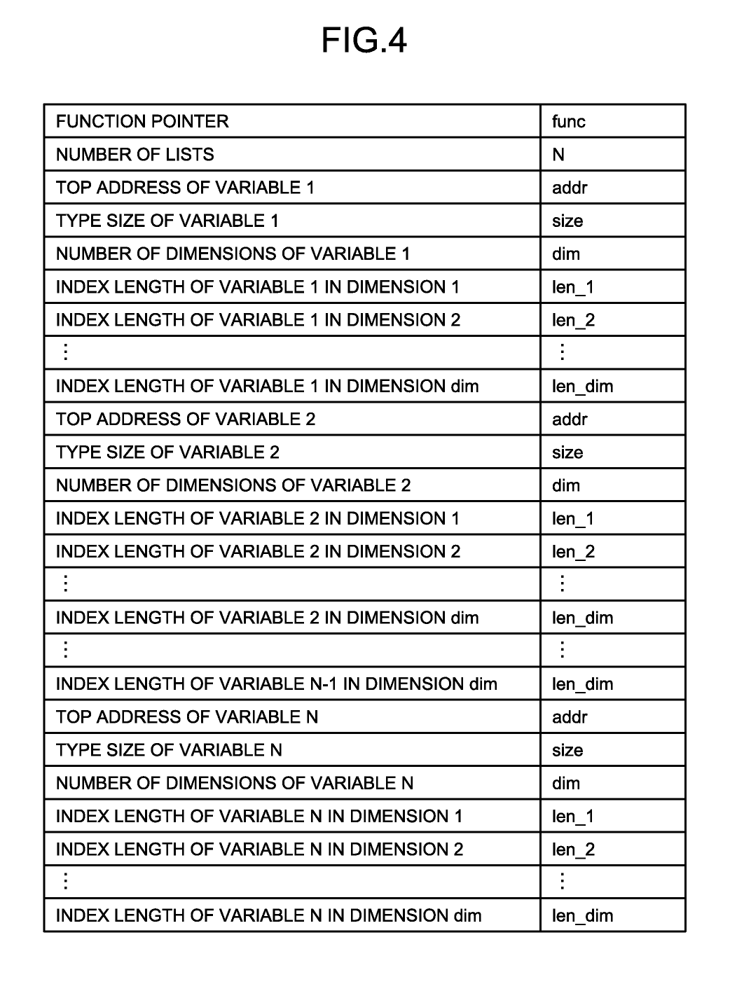

FIG. 4 is a diagram illustrating the arguments that are passed to a run time routine in the task registration I/F. As illustrated in FIG. 4, in the task registration I/F, in the arguments passed to the run time routine, the function pointer “func” of the task and the number “N” of lists are included. Furthermore, in the task registration I/F, in the arguments that are passed to the run time routine, regarding each of the variables, the top address “addr”, the type size “size”, the number of dimensions “dim”, and the index length “len_1” to “len_dim” of each of the dimensions are included.

The execution device 4 reads the latency table and the execution program from, for example, a file and executes the execution program. The execution device 4 includes a storage unit 40, a registration I/F execution unit 41, and an execution I/F execution unit 42.

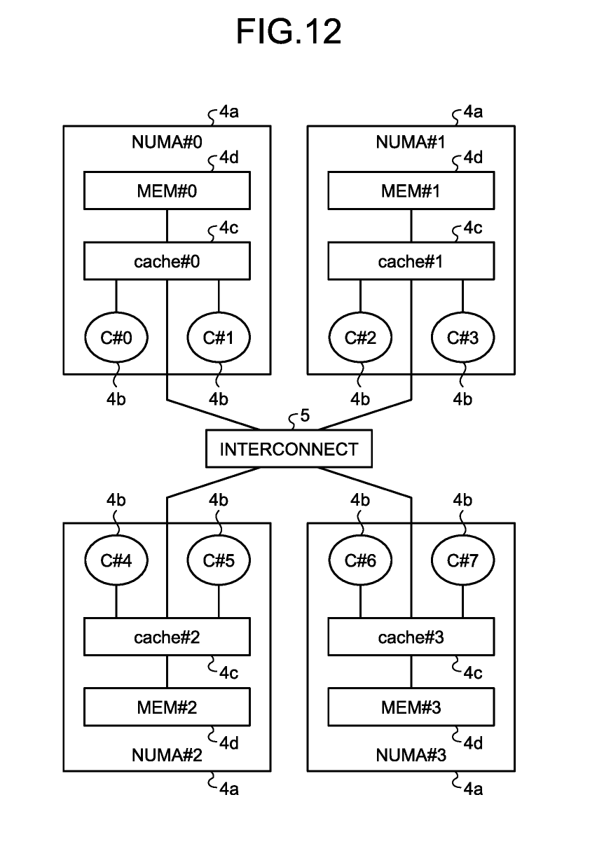

The execution device 4 has the hardware configuration in which, as illustrated in the example illustrated in FIG. 12 that will be described later, a plurality of NUMA nodes are connected by interconnection. The storage unit 40 is an area of a memory in one of the NUMA nodes. The registration I/F execution unit 41 and the execution I/F execution unit 42 are implemented by executing the run time routine of each of the task registration I/F and the task execution I/F in the core in the same NUMA node as the storage unit 40.

The storage unit 40 stores therein data used by the run time routines of the task registration I/F and the task execution I/F and stores therein a data size table 40a, a cost table 40b, and a task pool 40c.

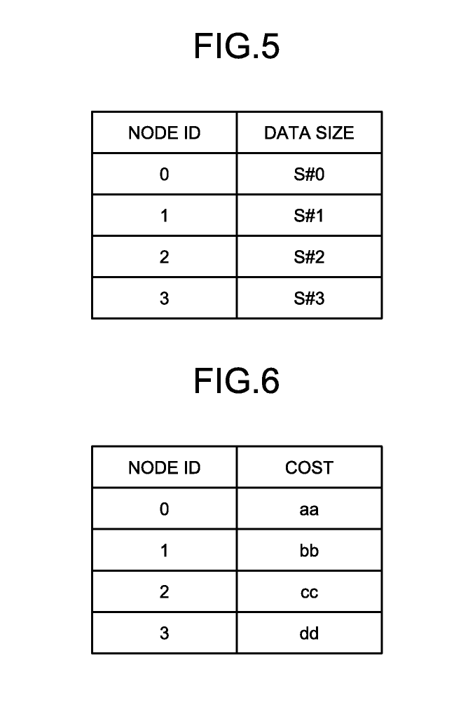

The data size table 40a is a table that stores therein, regarding the data used in a task, the size of data stored by each of the NUMA nodes. FIG. 5 is a diagram illustrating an example of the data size table 40a. As illustrated in FIG. 5, the data size table 40a associates the node ID with the data size. The node ID is an identifier for identifying the NUMA node that stores therein the data used by a task. The data size is the size of data stored in the associated NUMA node. For example, the size of the data stored in the NUMA node “0” regarding the task is “s#0”.

The cost table 40b is a table in which the NUMA node that executes a task is associated with a transfer cost of data. FIG. 6 is a diagram illustrating an example of the cost table 40b. As illustrated in FIG. 6, the cost table 40b associates the node ID with a cost. The node ID is an identifier for identifying the NUMA node that executes a task. The cost is a transfer cost of data in a case where the task is executed in the associated NUMA node. For example, if a task is executed in the NUMA node “0”, the transfer cost of the data is “aa”.

The task pool 40c is a list of information related to tasks that are waiting to be executed. In the information related to the tasks, a function pointer and the thread ID of the thread that executes the task are included.

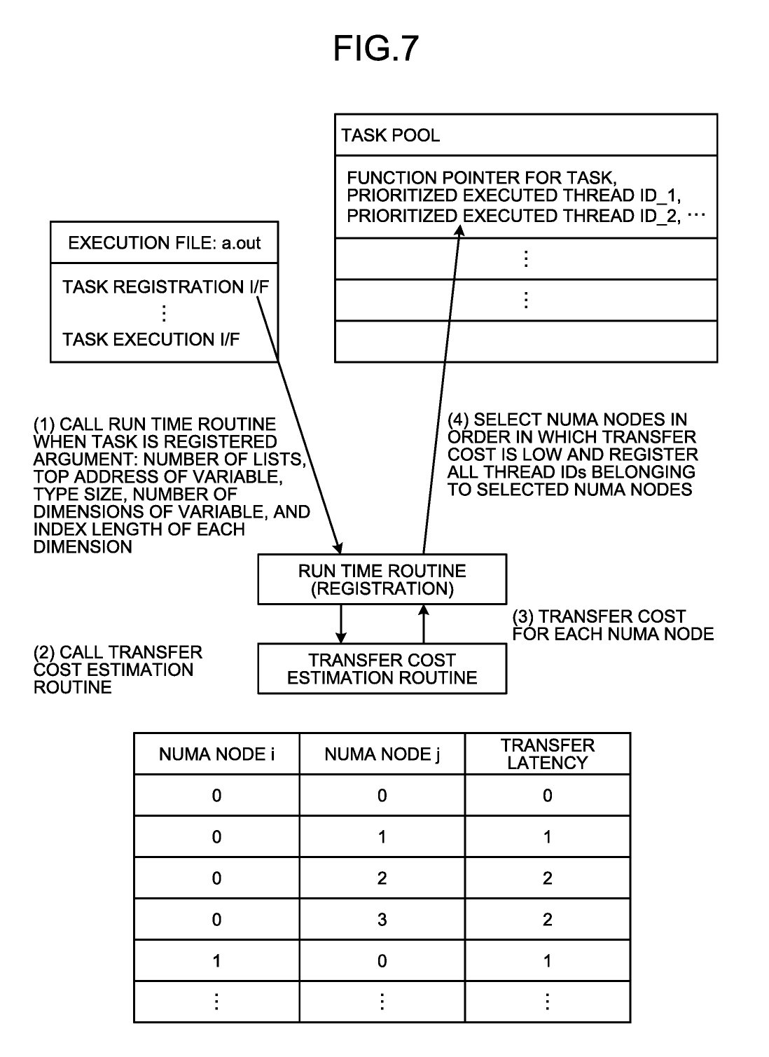

The registration I/F execution unit 41 executes the task registration I/F. FIG. 7 is a diagram illustrating an operation of the task registration I/F. As illustrated in FIG. 7, if the task registration I/F is called from the user program and is executed, a registration-purpose run time routine is called by passing, as the argument, the number of lists and by passing, as the arguments, the top address of the variable, the type size of the variable, the number of dimensions of the variable, and the index length of each of the dimensions, the number of which corresponds to the number of lists (1). Then, the registration-purpose run time routine calls the transfer cost estimation routine by passing, as the argument, the number of lists and by passing, as the arguments, the top address of the variable, size of the type of variable, the number of dimensions of variable, and the index length of each of the dimensions, the number of which corresponds to the number of lists (2).

Then, the transfer cost estimation routine creates the cost table 40b by using the arguments and the latency table and returns as a transfer cost for each NUMA node (3). Then, the registration-purpose run time routine sequentially selects NUMA nodes in the order in which the transfer cost is low and then registers all of the thread IDs belonging to the selected NUMA nodes into the task pool 40c together with the function pointers (4). In FIG. 7, a prioritized executed thread ID_1, a prioritized executed thread ID_2, and the like are the registered thread IDs.

The registration I/F execution unit 41 includes an extracting unit 41a, a calculation unit 41b, and a deciding unit 41c. The extracting unit 41a extracts a candidate NUMA node that becomes a candidate for executing a task. Specifically, the extracting unit 41a extracts, as the candidate NUMA node, the NUMA node to which a plurality of variables included in the arguments in the task registration I/F belongs.

Regarding the data used in a task, the calculation unit 41b calculates the size of data held in the candidate NUMA node. Specifically, the calculation unit 41b creates the data size table 40a.

The deciding unit 41c decides, by using the size of the data held by the candidate NUMA node and by using the latency table, the NUMA node that executes the task from among the candidate NUMA nodes. Then, the deciding unit 41c registers, in the task pool 40c, the thread ID of the thread that belongs to the decided NUMA node.

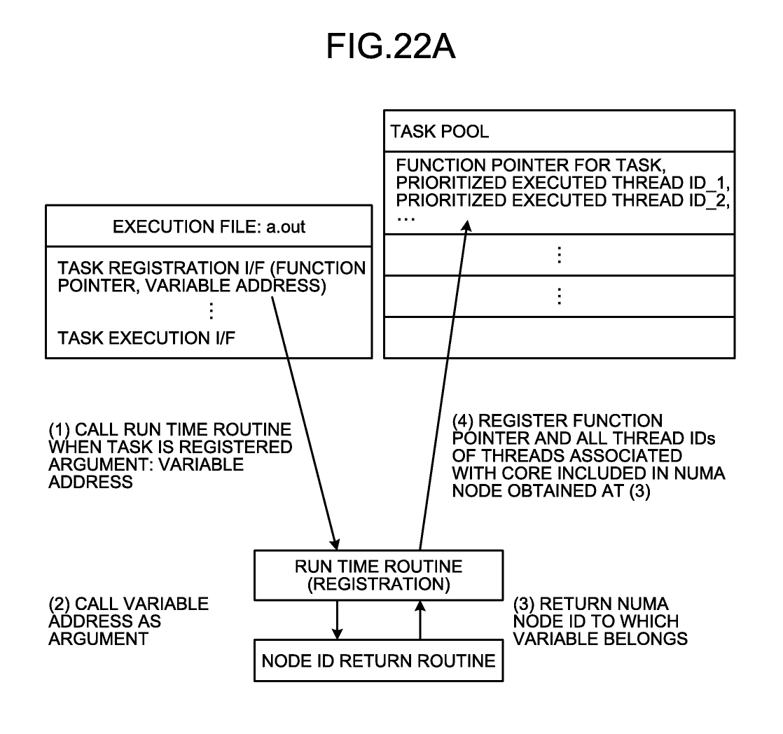

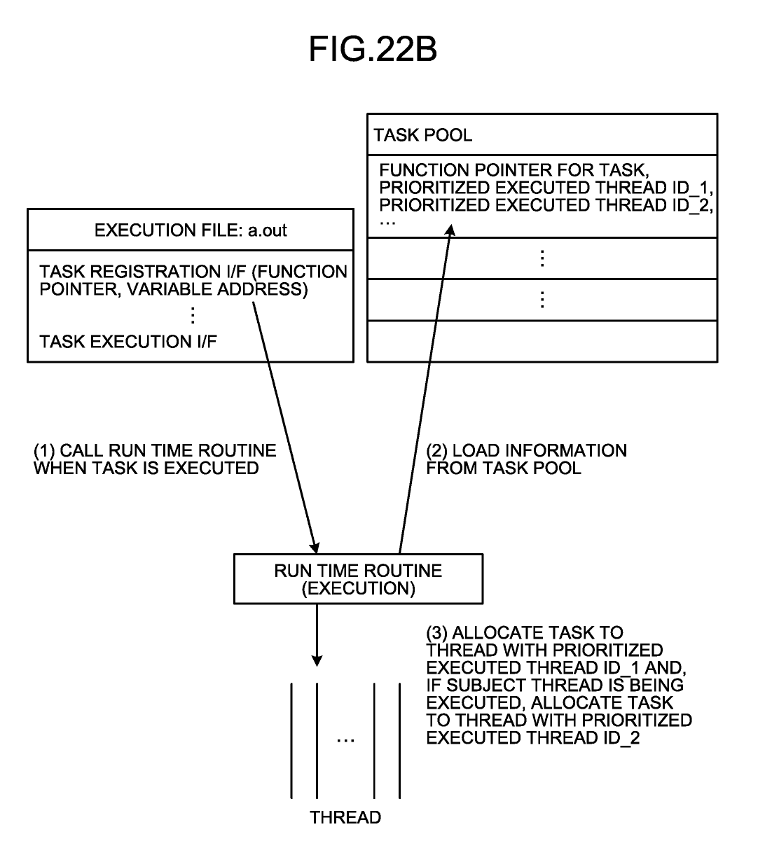

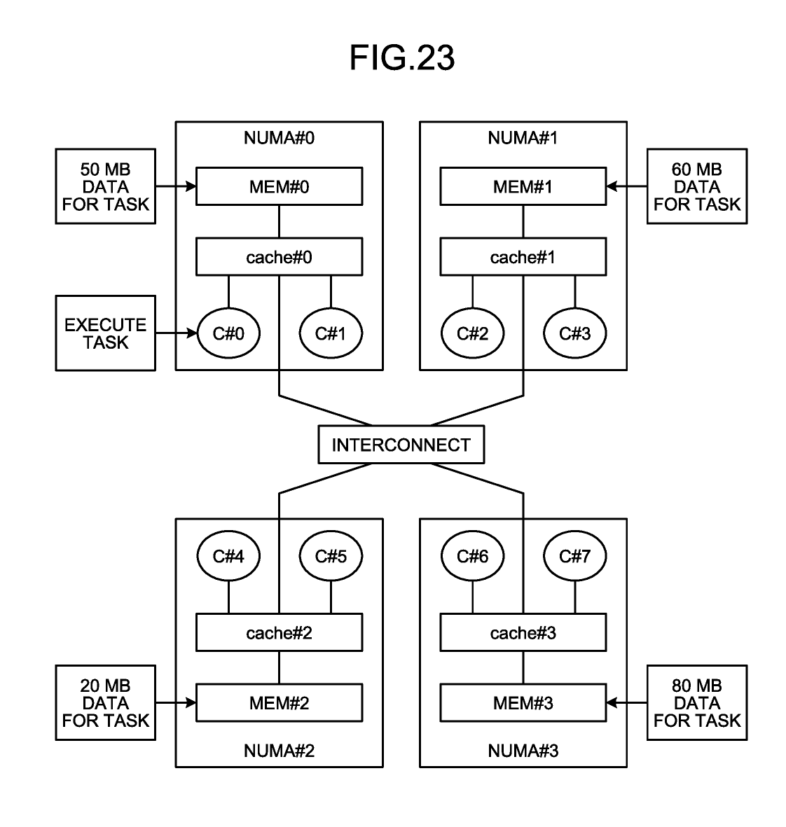

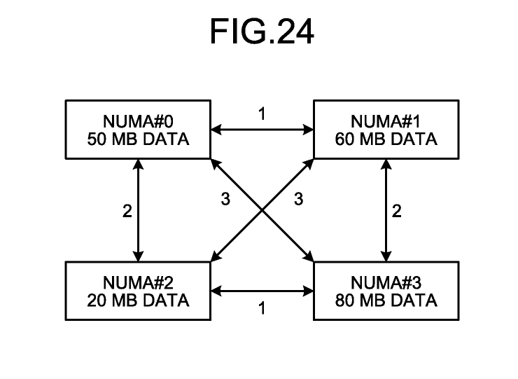

The execution I/F execution unit 42 executes the task execution I/F. task The execution I/F executes the task by performing the operation illustrated in FIG. 22B.

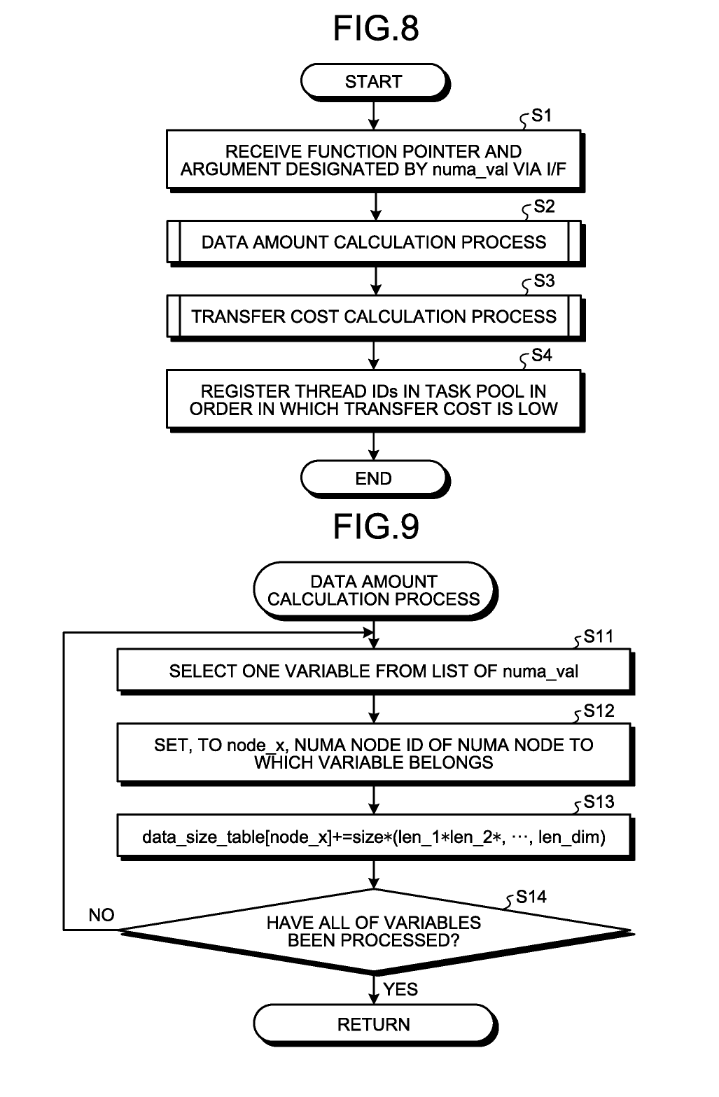

In the following, the flow of a process of the task registration I/F will be described. FIG. 8 is a flowchart illustrating the flow of a process of the task registration I/F. As illustrated in FIG. 8, the registration-purpose run time routine receives a function pointer and the argument designated by numa_val via an I/F (Step S1).

Then, the registration-purpose run time routine calls the transfer cost estimation routine and executes a data amount calculation process of calculating, for each NUMA node, the size of the data designated by numa_val (Step S2). Then, the registration-purpose run time routine calls the transfer cost estimation routine and executes the transfer cost calculation process of calculating the transfer cost (Step S3). Then, the registration-purpose run time routine associates the thread IDs with function pointers and sequentially registers the thread IDs in the task pool 40c in the order in which the transfer cost is low (Step S4).

In this way, because the registration-purpose run time routine associates the thread IDs with the function pointers and sequentially registers, in the task pool 40c, the thread IDs in the order in which the transfer cost is low, the information processing apparatus 1 can suppress a decrease in performance due to a remote access at the time of executing a task.

FIG. 9 is a flowchart illustrating the flow of the data amount calculation process. As illustrated in FIG. 9, the transfer cost estimation routine selects one variable from the list of numa_val (Step S11). Then, the transfer cost estimation routine sets, to node_x, the node ID of the NUMA node to which the variable belongs (Step S12). The transfer cost estimation routine identifies the NUMA node to which the variable belongs from the address of the variable and identifies node x by using the NUMA node ID return routine that returns the node ID.

Then, the transfer cost estimation routine updates, based on data_size_table[node_x]+=size*(len_1*len_2* . . . * len_dim), the data size in the NUMA node to which the variable belongs (Step S13). Here, data_size_table represents the data size table 40a and “*” represents multiplication.

Then, the transfer cost estimation routine determines whether all of the variables have been processed (Step S14). If an unprocessed variable is present, the transfer cost estimation routine returns to Step S11, whereas, if all of the variables have been processed, the transfer cost estimation routine ends the process.

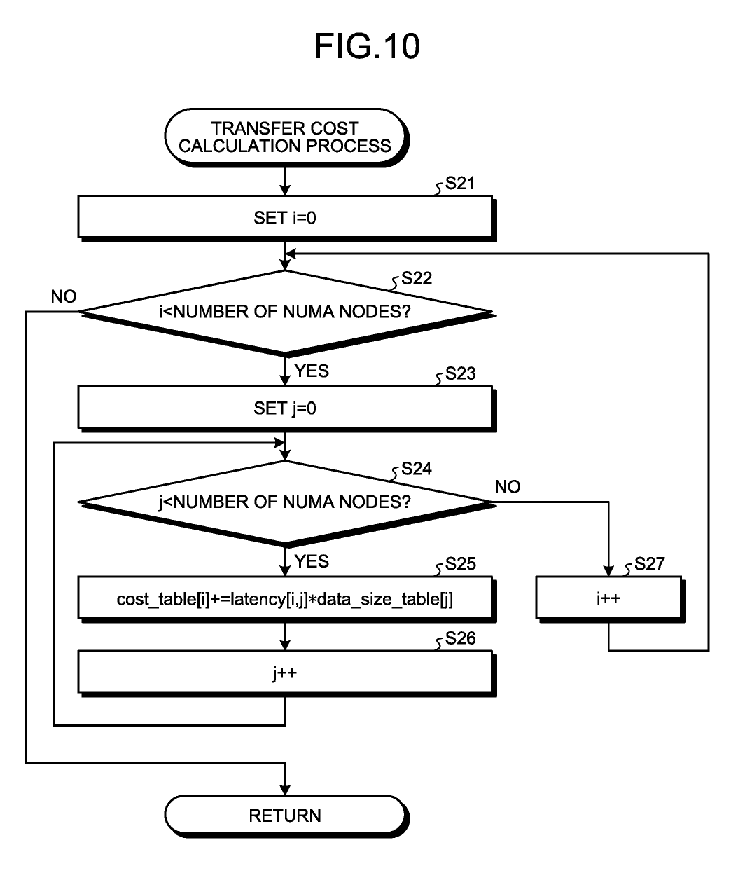

FIG. 10 is a flowchart illustrating the flow of a transfer cost calculation process. As illustrated in FIG. 10, the transfer cost estimation routine sets to i=0 (Step S21) and determines whether i is smaller than the number of NUMA nodes (Step S22). Here, the number of NUMA nodes indicates the number of NUMA nodes in which the data used by the task is allocated.

Then, if i is smaller than the number of NUMA nodes, the transfer cost estimation routine sets to j=0 (Step S23) and determines whether j is smaller than the number of NUMA nodes (Step S24).

If j is smaller than the number of NUMA nodes, the transfer cost estimation routine updates, based on cost_table[i]+=latency[i,j]*data_size_table[j], the transfer cost of i^{th} NUMA node (Step S25). Here, cost table represents the cost table 40b and the latency represents the latency table.

Then, transfer cost estimation routine adds 1 to j (Step S26) and returns to Step S24. If j is not smaller than the number of NUMA nodes, the transfer cost estimation routine adds 1 to i (Step S27) and returns to Step S22. If i is not smaller than the number of NUMA nodes, the transfer cost estimation routine ends the process.

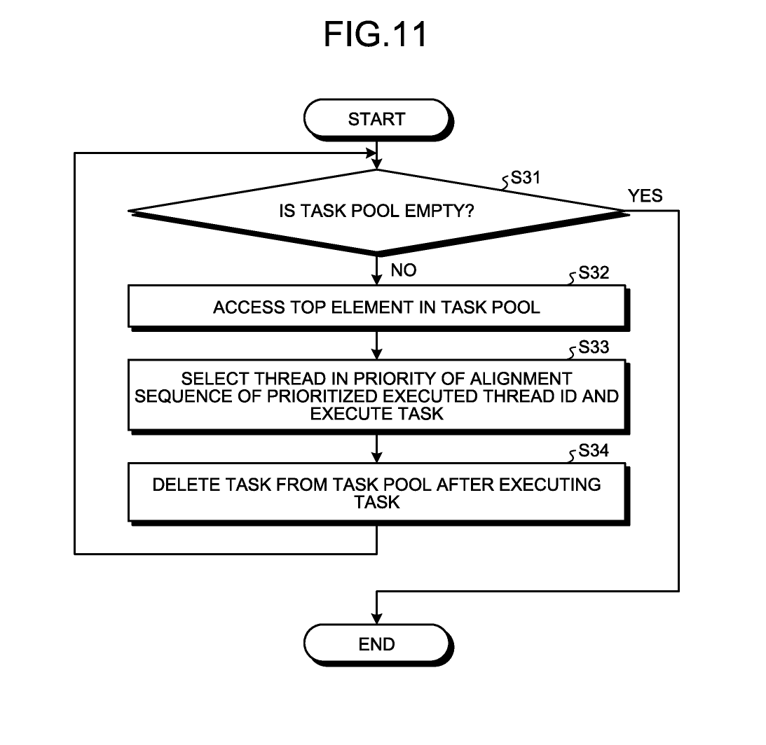

In the following, the flow of a process of the task execution I/F will be described. FIG. 11 is a flowchart illustrating the flow of a process of the task execution I/F. As illustrated in FIG. 11, the execution-purpose run time routine determines whether the task pool 40c is empty (Step S31) and, if the task pool 40c is empty, the execution-purpose run time routine ends the process.

In contrast, if the task pool 40c is not empty, the execution-purpose run time routine accesses the top element in the task pool 40c (Step S32), and sequentially selects a thread in the priority of alignment sequence of the prioritized executed thread IDs and executes the task (Step S33). Then, after having executed the task, the execution-purpose run time routine deletes the task from the task pool 40c (Step S34) and returns to Step S31.

In this way, because the execution-purpose run time routine sequentially selects the thread in the priority of the alignment sequence of the prioritized executed thread IDs and executes the task, the information processing apparatus 1 can suppress a decrease in performance due to a remote access when executing the task.

In the following, an example of registration into the task pool 40c will be described with reference to FIGS. 12 to 18. FIG. 12 is a diagram illustrating the hardware configuration of the execution device 4 that is used to explain registration into the task pool 40c. As illustrated in FIG. 12, the execution device 4 includes four NUMA nodes 4a represented by NUMA#0 to NUMA#3. The node ID of NUMA#0 is “0”, the node ID of NUMA#1 is “1”, the node ID of NUMA#2 is “2”, and the node ID of NUMA#3 is “3”. The four NUMA nodes 4a are connected by an interconnect 5.

The NUMA node #0 includes cores 4b represented by C#0 and C#1, a cache memory 4c represented by cache#0, and a memory 4d represented by MEM#0. The NUMA node #1 includes cores 4b represented by C#2 and C#3, a cache memory 4c represented by cache#1, and a memory 4d represented by MEM#1.

The NUMA node #2 includes cores 4b represented by C#4 and C#5, a cache memory 4c represented by cache#2, and a memory 4d represented by MEM#*2. The NUMA node #3 includes cores 4b represented by C#6 and C#7, a cache memory 4c represented by cache#3, and a memory 4d represented by MEM#3.

The core ID of C#0 is “0”, the core ID of C#1 “1”, the core ID of C#2 is “2”, and the core ID of C#3 is “3”. The core ID of C#4 is “4”, the core ID of C#5 is “5”, the core ID of C#6 is “6”, and the core ID of C#7 is “7”. The core ID and the thread ID are the same.

The core 4b is an arithmetic processing device that reads a program from the cache memory 4c and that executes the program. The cache memory 4c is a storage module that stores therein the program and a part of data stored in the memory 4d. The memory 4d is a random access memory (RAM) that stores therein a program or data.

The program executed in the cores 4b is installed in a hard disk drive (HDD) via a file output by, for example, the compile device 3 and is read from the HDD to the memory 4d. Alternatively, the program executed in the cores 4b is stored in a DVD and is read from a DVD into the memory 4d.

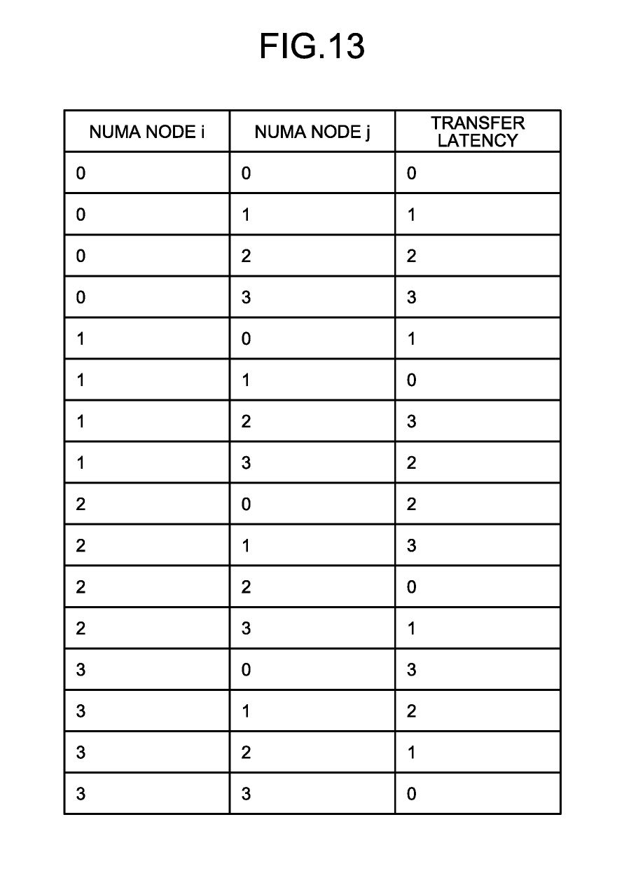

FIG. 13 is a diagram illustrating a latency table of the execution device 4 illustrated in FIG. 12. For example, the transfer latency between NUMA#0 and NUMA#1 is “1”, the transfer latency between NUMA#0 and NUMA#2 is “2”, and the transfer latency between NUMA#0 and NUMA#3 is “3”.

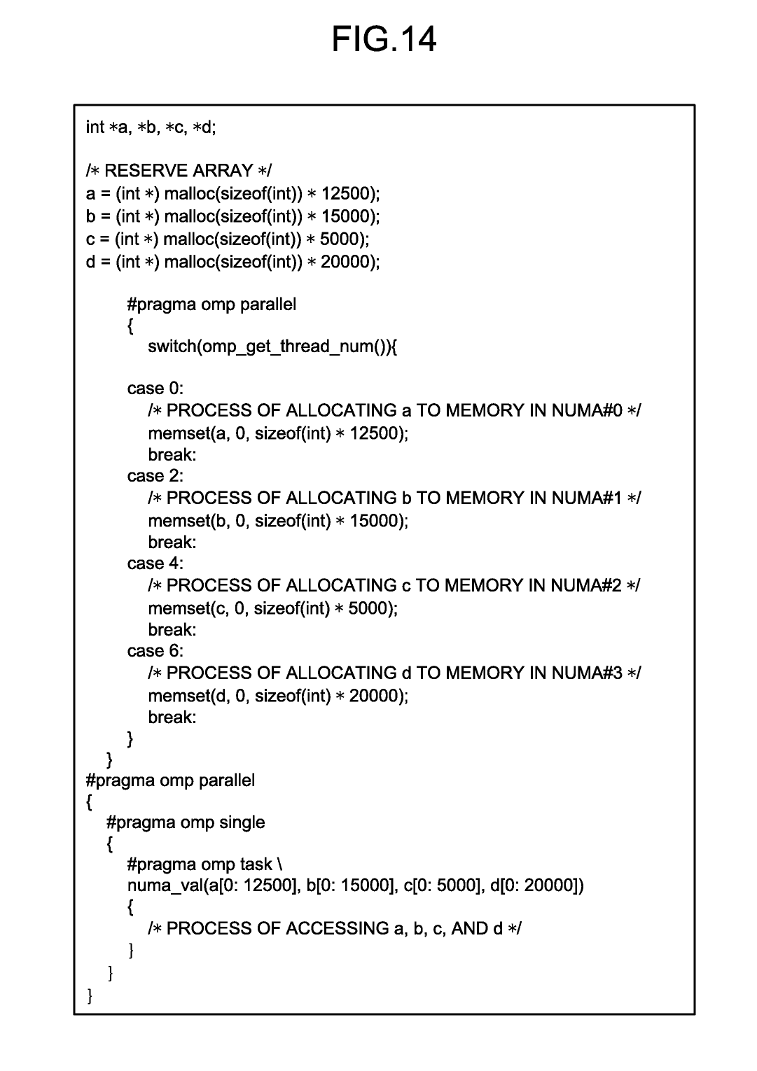

FIG. 14 is a diagram illustrating a program used to explain registration into the task pool 40c. In FIG. 14, a represents a one-dimensional array with the size of 12500, b represents a one-dimensional array with the size of 15000, c represents a one-dimensional array with the size of 5000, and d represents a one-dimensional array with the size of 20000. Furthermore, “#pragma omp parallel{switch . . . }” allocates a to NUMA#0, allocates b to NUMA#1, allocates c to NUMA#2, and allocates d to NUMA#3. Furthermore, numa_val(a[0:12500],b[0:15000],c[0:5000],d[0:20000]) designates that the task uses a, b, c, and d. Furthermore, “\” in “#pragma omp task\” represents continuation of the line.

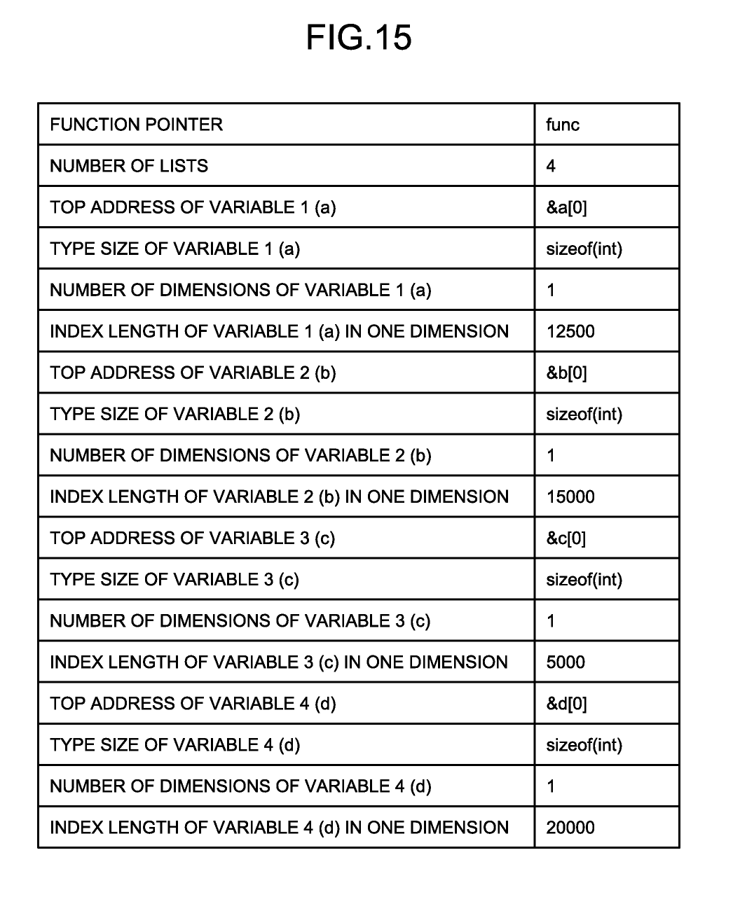

FIG. 15 is a diagram illustrating arguments of the task registration I/F in the program illustrated in FIG. 14. The compile device 3 compiles “#pragma omp task numa_val(a[0:12500],b[0:15000],c[0:5000],d[0:20000])” and creates the task registration I/F having the arguments illustrated in FIG. 15.

The registration-purpose run time routine receives all of the arguments illustrated in FIG. 15 and calculates the amount of data allocated to each of the NUMA nodes. For example, the registration-purpose run time routine identifies the NUMA node to which the variable a is allocated and then calculates the allocated amount of data.

Specifically, the registration-purpose run time routine calls the top address &a[0] as the argument for a system call (get_mempolicy) that identifies the node ID from the address and then identifies the node ID of the NUMA node to which a belongs. Here, the node ID “0” is identified.

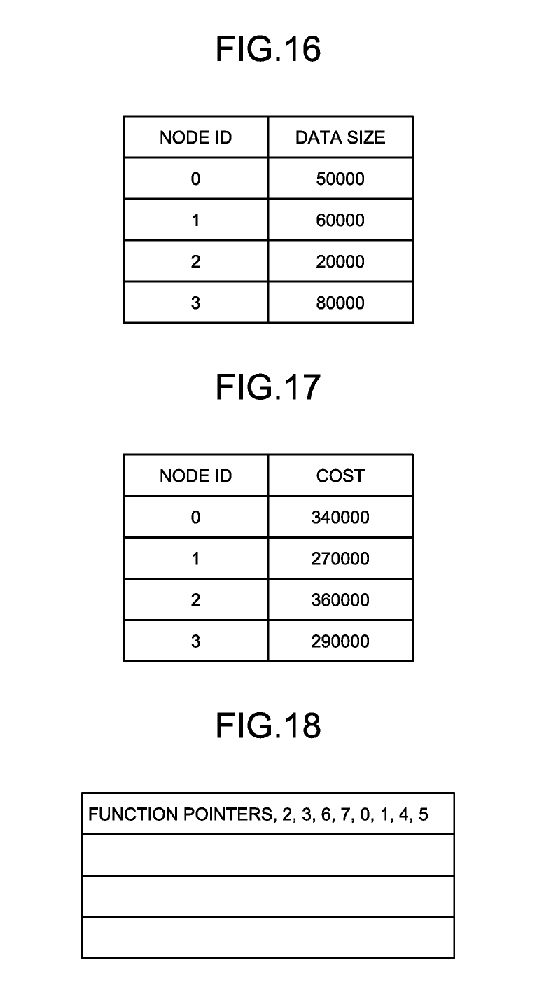

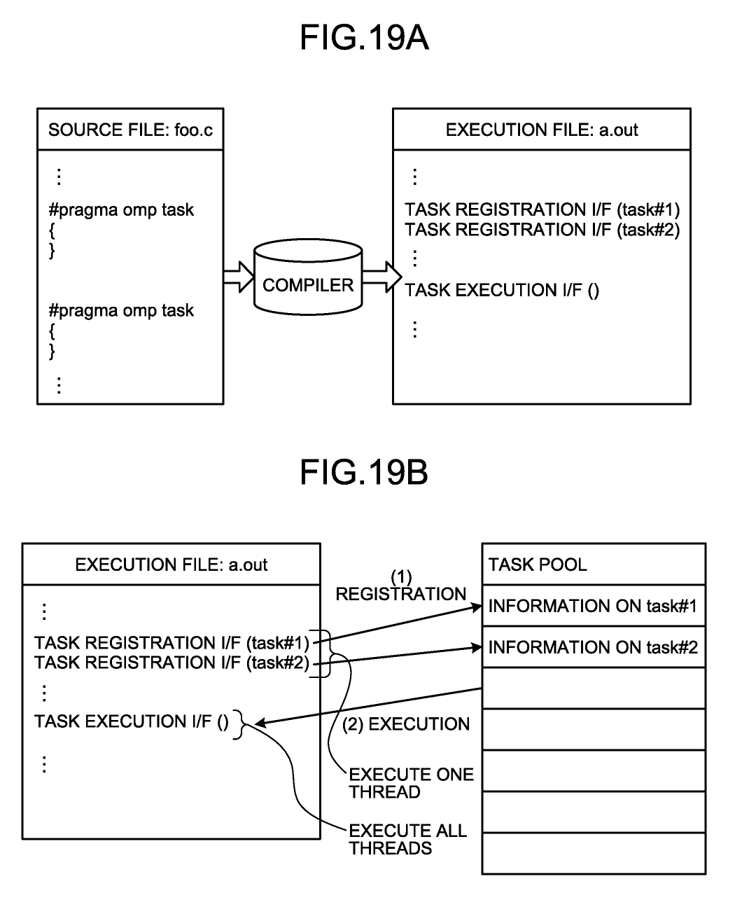

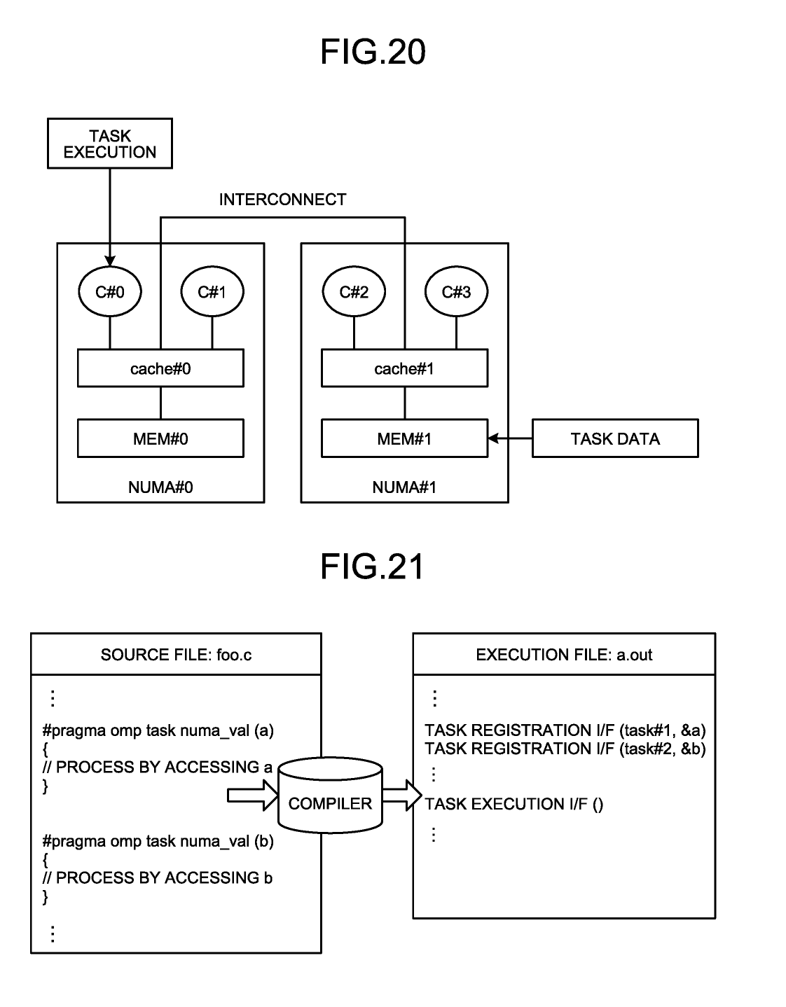

Because the amount of data can be calculated from the (type size)*((index length of dimension 1)* . . . *(index length of dimension dim)), sizeof(int)*12500=4*12500=50000 byte is obtained. Namely, regarding the variable a, because 50000 bytes are allocated to the NUMA node “0”, data size table[0]=50000 is obtained. Similarly, data size table[1]=60000, data size table[2]=20000, and data size table[3]=80000 are obtained. FIG. 16 is a diagram illustrating the data size table 40a created about variables illustrated in FIG. 15.

The registration-purpose run time routine calculates the cost table 40b from the latency table illustrated in FIG. 13 and the data size table 40a illustrated in FIG. 16. For example, the cost of NUMA#0 is calculated as follows:

cost_table[0]=latency[0,0]*data size table[0]+ . . . +latency[0, 3]*data size table[3]=0+1*60000+2*20000+3*80000=340000. Similarly, cost_table[1]=270000, cost_table[2]=360000, and cost_table[3]=290000 are calculated. FIG. 17 is a diagram illustrating the cost table 40b calculated from the latency table illustrated in FIG. 13 and the data size table 40a illustrated in FIG. 16.

Based on FIG. 17, the registration-purpose run time routine decides that the tasks are executed in the order in which the costs are smaller, i.e., the priority of NUMA#1, NUMA#3, NUMA#0, and NUMA#2. Then, the registration-purpose run time routine uses a system call that returns all of the thread IDs included in the NUMA node by using the node ID as the argument and then identifies the thread IDs “2 and 3” included in NUMA#1. Similarly, the registration-purpose run time routine identifies the thread IDs “6 and 7” included in NUMA#3, thread IDs “0 and 1” included in NUMA#0, and the thread IDs “4 and 5” included in NUMA#2.

Then, the registration-purpose run time routine registers the identified thread IDs in the task pool 40c together with the function pointer in the order of the priorities. FIG. 18 is a diagram illustrating the task pool 40c after registration.

As described above, in the embodiment, the extracting unit 41a extracts a candidate NUMA node that becomes a candidate for executing a task and, regarding the data used in the task, the calculation unit 41b calculates the size of the data held by the candidate NUMA node. Then, the deciding unit 41c decides, by using the size of the data held by the candidate NUMA node and by using the latency table, the NUMA node that executes the task from among the candidate NUMA nodes. Then, the deciding unit 41c registers the thread ID of the thread associated with the core that belongs to the decided NUMA node into the task pool 40c. Consequently, the registration-purpose run time routine can suppress a decrease in performance due to a remote access when executing the task.

Furthermore, in the embodiment, the registration I/F execution unit 41 that includes the extracting unit 41a, the calculation unit 41b, and the deciding unit 41c calls the registration-purpose run time routine and executes the task registration I/F. The registration-purpose run time routine receives the addresses of the variables used in the task as arguments. Consequently, the extracting unit 41a can extract, as the candidate NUMA node, the NUMA node in which the variable is allocated from the address of the variable.

Furthermore, in the embodiment, because the registration-purpose run time routine receives the top address of the variable, the size of the type of the variable, the number of dimensions of the variable, the size of each of the dimensions as the arguments, the calculation unit 41b can calculate the size of the data included in the candidate NUMA node.

Furthermore, in the embodiment, because the extracting unit 41a extracts, as the candidate NUMA nodes, the NUMA nodes to which a plurality of variables included in the arguments of the task registration I/F belong, the candidate NUMA nodes can be accurately extracted.

Furthermore, in the embodiment, because a plurality of variables included in the arguments in the task registration I/F is designated by the numa_val designation clause, a user can suppress a decrease in performance due to a remote access by describing, in the numa_val designation clause, a plurality of variables used for the task.

According to an aspect of an embodiment, the present invention can suppress a decrease in performance due to a remote access.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium having stored therein an execution node selection program that causes a computer to execute a process comprising:
extracting, as a candidate NUMA node, a NUMA node in which data used by a task that is cut out from a source program is allocated as a portion subjected to parallel execution in a parallel computer that has a plurality of NUMA nodes;
calculating a size of the data for each extracted candidate NUMA node; and
deciding, based on the calculated size and latency when the data is transferred between the candidate NUMA nodes, a NUMA node that executes the task from among the candidate NUMA nodes.

2. The execution node selection program according to claim 1, wherein
the execution node selection program is executed as a run time library, and
the execution node selection program is called from an execution program with information related to the data used by the task as an argument.

3. The execution node selection program according to claim 1, wherein, in the information related to the data used by the task, the top address of a variable, the size of the type of the variable, the number of dimensions of the variable, and the size of each of the dimensions are included.

4. The execution node selection program according to claim 2, wherein
the information related to the data used by the task is information related to a plurality of variables used by the task, and
the extracting the candidate NUMA node includes extracting, as the candidate NUMA nodes, NUMA nodes to each of which a corresponding variable in the plurality of variables included in arguments belongs at the time of call.

5. The execution node selection program according to claim 4, wherein the plurality of variables is designated by a numa_val designation clause in the source program.

6. An execution node selection method performed by a computer comprising:
extracting, as a candidate NUMA node, a NUMA node in which data used by a task that is cut out from a source program is allocated as a portion subjected to parallel execution in a parallel computer that has a plurality of NUMA nodes;
calculating a size of the data for each extracted candidate NUMA node; and
deciding, based on the calculated size and latency when the data is transferred between the candidate NUMA nodes, a NUMA node that executes the task from among the candidate NUMA nodes.

7. An information processing apparatus comprising:
an extracting unit that extracts, as a candidate NUMA node, a NUMA node in which data used by a task that is cut out from a source program is allocated as a portion subjected to parallel execution in a parallel computer that has a plurality of NUMA nodes;
a calculation unit that calculates a size of the data for each candidate NUMA node extracted by the extracting unit; and
a deciding unit that decides, based on the size calculated by the calculation unit and latency when the data is transferred between the candidate NUMA nodes, a NUMA node that executes the task from among the candidate NUMA nodes.
